(19) United States
(12) Patent Application Publication
(10) Pub. No.: US 2005/0174958 A1
(43) Pub. Date: Aug. 11, 2005

(54) Method and system for prioritazation and dynamic channel allocation within a communication system

(75) Inventors: Michael J. Miller, Pleasant Grove, UT (US); Lyman D. Horne, Salt Lake City, UT (US); W. Paul Willes, Alpine, UT (US); Douglas M. Grover, Elk Ridge, UT (US)

Correspondence Address: Lloyd W. Sadler;Parsons Behle & Latimer, Suite 1800, 201 South Main Street, Salt Lake City, UT, 84111, US

(73) Assignee: Phonex Broadband Corporation, Midvale, UT (US)

(21) Appl. No.: 10/776,443

(22) Filed: Feb. 11, 2004

(51) Int. Cl. H04B 7/212

(52) U.S. Cl. 370/321

(57) ABSTRACT

A bandwidth allocation method and system designed to provide efficient bandwidth utilization based on data priority and needs of network nodes. This invention provides a specific design for dynamically creating, deleting, resizing, and reclaiming network channels based on priority and the needs of existing connections within a network or within multiple networks. Additionally, this invention provides a process to make channels and their encryption keys persistent through the creation of virtual channels which are made active when data needs to be transferred.

### BACKGROUND OF INVENTION

1. Field of the Invention

This invention relates to electronic communication systems. More specifically, this invention relates communications systems that create, delete and resize channels on a network.

2. Description of Related Art

A variety of schemes have been used for bandwidth allocation which facilitate communication across a network. Multiple methods have been employed which create channels of varying sizes based the type of connection being created. These are typically targeted at high bandwidth systems, not wireless or AC power line systems. Although the references may not constitute prior art, for general background material, the reader is directed to the following United States patents, each of which is hereby incorporated by reference in its entirety for the material contained therein: U.S. Pat. Nos. 6,456,633, 6,366,587, 6,292,644, 6,272,348, 6,195,362, 6,009,106, 5,838,681, 5,673,253, 5,594,727, 5,592,470, and 5,313,467.

### SUMMARY OF INVENTION

It is desirable to provide a bandwidth allocation system that fully utilizes the available bandwidth while still providing access to higher priority data transfer by resizing or removing lower priority connections.

Therefore it is a general object of this invention to provide a bandwidth allocation system that makes use of a time division multiplexed network.

It is still a further object of an embodiment of this invention to provide a bandwidth allocation system to provide data transfer between nodes on a network.

It is still a further object of an embodiment of this invention to provide a bandwidth allocation system that adapts the channel sizes based on the priority and type of connection.

It is still a further object of an embodiment of this invention to provide a bandwidth allocation system that dynamically creates channels.

It is still a further object of an embodiment of this invention to provide a bandwidth allocation system that dynamically resizes channels.

It is still a further object of an embodiment of this invention to provide a bandwidth allocation system that dynamically deletes channels.

It is still a further object of an embodiment of this invention to provide a bandwidth allocation system that reclaims channels based on querying network nodes.

It is still a further object of an embodiment of this invention to provide a bandwidth allocation system to provide network connectivity across a power line network, a wireless network, a light frequency network, and a wired network.

It is a still further object of an embodiment of this invention to provide a bandwidth allocation system to provide encrypted channels which ensure secure data transfer.

It is a still further object of an embodiment of this invention to provide a bandwidth allocation system which can provide bandwidth allocation between multiple networks sharing the same, similar or separate physical mediums.

It is a still further object of an embodiment of this invention to provide a bandwidth reclamation system which can provide the ability to identify when nodes are no longer using bandwidth and reclaim their bandwidth even though the nodes cannot be communicated with.

These and other objects of this invention will be readily apparent to those of ordinary skill in the art upon review of the following drawings, detailed description, and claims. In the preferred embodiment of this invention, the bandwidth allocation system makes use of a novel channel allocation scheme based on priorities that efficiently utilizes the existing network bandwidth.

### BRIEF DESCRIPTION OF DRAWINGS

In order to show the manner that the above recited and other advantages and objects of the invention are obtained, a more particular description of the present preferred embodiments of this invention, which are illustrated in the appended drawings, is described as follows. The reader should understand that the drawings depict only present preferred and best mode embodiments of the invention, and are not to be considered as limiting in scope. A brief description of the drawings is as follows:

FIG. 1a is a diagram of the present preferred network for sending data segments between network nodes.

FIG. 1b is a diagram of the Time Division Multiplexed structure of the present preferred embodiment of this invention used to transfer data on a network.

FIG. 2 is a flow diagram of the present preferred virtual channel creation process from the node which is requesting to create a virtual channel.

FIG. 3 is a flow diagram of the present preferred virtual channel creation process from the node which is being requested to be apart of the virtual channel.

FIG. 4 is a flow diagram of the present preferred virtual channel removal process once a virtual channel is created.

FIG. 5 is a flow diagram of the present preferred control node active channel creation process.

FIG. 6a is a flow diagram of the present preferred channel creation process for a peer active channel.

FIG. 6b is a diagram of the present preferred dynamic active channel resizing.

FIG. 7 is a flow diagram of the present preferred process for bandwidth allocation using channel priorities.

FIG. 8 is a flow diagram of the present preferred process for bandwidth reclamation in a control node active channel.

FIG. 9 is a flow diagram of the present preferred process for notifying network nodes that the network node is no longer part of an active channel.

FIG. 10 is a diagram of the present preferred process for bandwidth reclamation in a peer active channel.

Reference will now be made in detail to the present preferred embodiment of the invention, examples of which are illustrated in the accompanying drawings.

### DETAILED DESCRIPTION

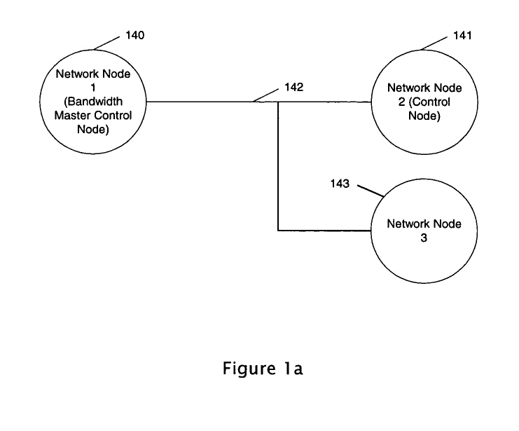

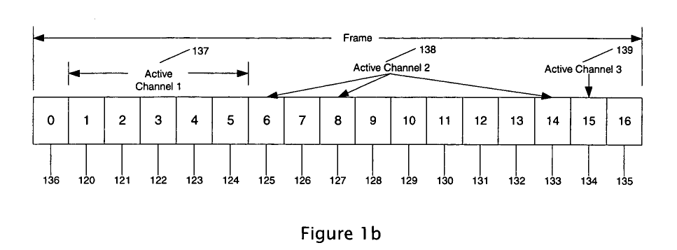

FIG. 1a is a diagram of the present preferred network for sending data segments between network nodes. In this document when referring to a network node in the singular, while referencing the single node with multiple nodes indicates that all referenced nodes can perform the same function as the single network node. A network 142 is formed by plurality network nodes 140 and 141. One of the network nodes 140 is a bandwidth master control node. Segments (packets) are sent across a time division multiplexed data mechanism which contains a network 142 which further contains time slots 120-136.

FIG. 1b is a diagram of the time division multiplexed data transfer mechanism of the present preferred embodiment of this invention used to transfer data on a network 142. Transfer of data across a network 142 occurs in two forms: packets which are broken up into segments and non-packet. Examples of data include but are not limited to voice, audio, control, video, and computer information and the like. A frame represents the bandwidth of the network 142 over time and consists of a plurality of time slots 120-136. Time slots 120-136 in the present preferred embodiment are equal size pieces of Time Division Multiplexed (TDM) bandwidth which is used to transfer data over the AC power line or network 142. Each time slot is 10 bits wide. The actual data sent is 32 bits with 22 bits used for forward error correction which results in 10 bits for each time slot. This is a 5/16 rate code. Time slot 136 is used for frame synchronization across the network 142 and time slots 120-135 are used for data transfer. Data is sent using active channels 137-139, which are pieces of network 142 bandwidth. An active channel 137-139 is a variable or fixed size pipe made up of a single time slot or a plurality of time slots used to form a packet or non-packet pipe. For example, an active channel 137 can include but is not limited to a group of contiguous slots 120-124. On the other hand, an active channel 138 can consist of noncontiguous slots 126, 128, 133. In addition, an active channel 139 can include a single time slot 134 or any number of time slots up to the maximum number of time slots in the frame. An active channel 137-139 is created by a bandwidth master control node 140 which is a network node responsible for creating active channels 137, 138, and 139 in conjunction with network nodes 140, 141, 143 on a network 142. Any network node can assume the role of bandwidth master control node 140.

To transfer data between nodes, the user or application creates a Virtual Channel (VC) and creates an Active Channel (AC) 137-139. However, the virtual channel is not necessary if an active channel 137-139 does not need to be persistent. A virtual channel is a grouping of devices that eventually need to communicate with each other and can use the same service type. A service type is unique identifier that represents the type of data being transferred across a network 142. Virtual channels contain persistent information about how to setup an active channel 137-139 when bandwidth is needed. Active channels 137-139 are created and destroyed by a network node 140 that is responsible for bandwidth allocation called a bandwidth master control node 140. A bandwidth master control node 140 can control but is not limited to one or more distinct networks 142 using the same physical medium by using a network number to identify each network 142. An active channel 139 is instantiated when a network node 141 responsible for the active channel 139 needs to create an active channel 139, to pass data between network nodes 140, 141, 143 in a active channel 139. An active channel 139 will typically exist only as long as the network nodes 140, 141 need bandwidth to transfer data while a virtual channel can exists permanently (or until the user or application no longer needs it). On the other hand, an active channel may stay up permanently if necessary. Virtual channels and active channels 137-139 are created via a signaling channel (which is an active channel) which is used to exchange information between nodes.

Once the network 142 is created, virtual channels can be created. For example, virtual channels can be created for, but are not necessarily limited to Internet connections, alarm systems, appliances, home control systems, stereo systems, voice systems, and the like. This can occur from, but is not limited to an administrative console or an application going out and identifying which network nodes 140, 141 need to be apart of the virtual channel. A Virtual Channel Structure (VCS) is created which contains all the information necessary to create an active channel 139. This allows network nodes 140, 141, 143 to recreate an active channel 139 that existed when power was lost on the network 142. The virtual channel structure also keeps the network 142 and the active channel 139 secure by storing the encryption key information. The process is the same whether new network node 141, 142, 143 is being added to an existing virtual channel or creating a new virtual channel.

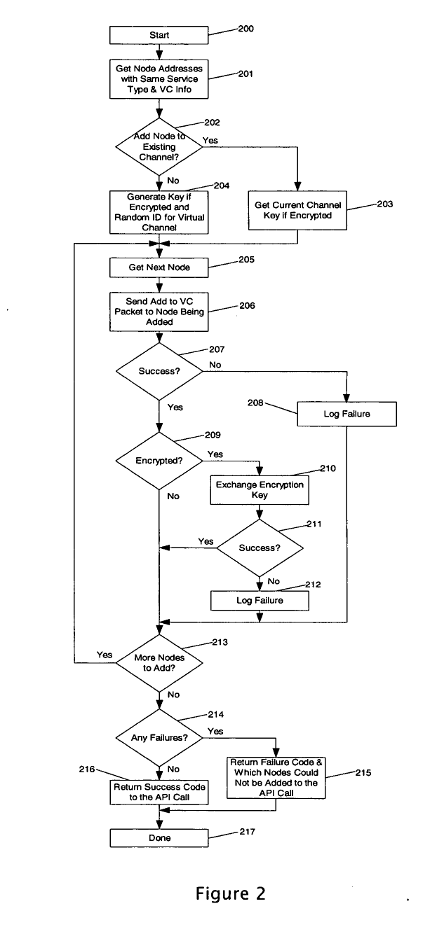

FIG. 2 is a flow diagram of the preferred virtual channel creation process from a network node 141 which is requesting to create a virtual channel 139. A request is made 200 to create a virtual channel. The user or application generates 201 a list of network nodes 140, 141, 143 and the service type that are part of the virtual channel. This coupled with a virtual channel name is used to create an active channel 139. At test 202 the network node 141 checks to see if an active channel 139 already exists. If so, the application goes out and gets 203 the existing encryption key for the virtual channel. Otherwise, the application generates 204 a random key and ID for the virtual channel. The virtual channel name and the random ID are used to uniquely identify a virtual channel. In order to create a virtual channel, all network nodes 140, 141, 143 that are part of the virtual channel should be able to communicate on the network 142 or at a later period in time if being added to the virtual channel. If a network node 140, 141, 143 was not a part of the initial virtual channel creation the network node 140, 141, 143 will have to be added by a network node 140, 141, or 143 that is already apart of the virtual channel in order to have a secure network. After getting 205 the next network node 140, 141, or 141 to be added, the packet to add the next node to the VC is sent 206. The packet contains the virtual channel information except the encryption key. If test 207 is not successful, an error is logged 208. If test 207 is successful, and if the active channel 139 is to be encrypted 209, the encryption key is passed 210 using an encryption key passing algorithm. The present preferred embodiment uses Diffie-Hellman key exchange, but any key exchange method can be used. The encryption key is exchanged 210. If test 211 is successful, the process continues to see if more network nodes 140, 141, 143 are to be added 213. Otherwise, an error is logged 212 for that network node 140, 141 or 143. Test 213 checks to see if there are other network nodes 140, 141 or 143 to be added to the virtual channel. If so the process gets 205 to be added to the virtual channel. Otherwise, there is a check 214 for any failures. If there were any failures logged in step 212, they are passed 215 back to the Application Programming Interface (API). Each network node 140, 141, 143 that failed to be added to the virtual channel and the reason why there was a failure is passed back 215 to the API. If there were not any failures in test 214, success is returned 216 to the API. The process completes 217.

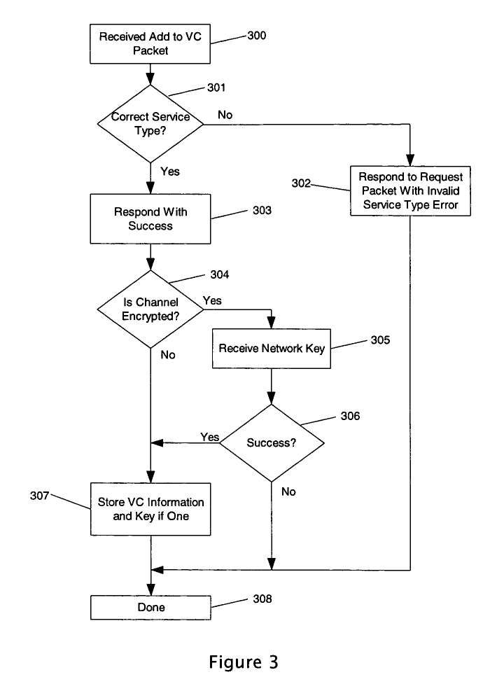

FIG. 3 is a flow diagram of the present preferred virtual channel creation process from the network node 140, 141, 143 which is being requested to be apart of the virtual channel, wherein FIG. 2 is the flow diagram from the node creating the virtual channel. When a network node 140, 141, 143 receives 300 an “add to virtual channel packet”, the network node 140, 141, 143 checks 301 the service type to make sure that the service type matches its own service type. If there is not a match, the network node 140, 141, 143 responds 302 with an error packet. If there is a match in test 301, the process responds 303 with a success in the packet status. If the active channel 139 is supposed to be encrypted in test 304, the encryption key exchange process is used 305 to exchange the virtual channel encryption key. If successful in test 306, the key and the virtual channel information are stored 307 and the process completes 308. If the encryption key exchange fails in test 306, the process completes 308.

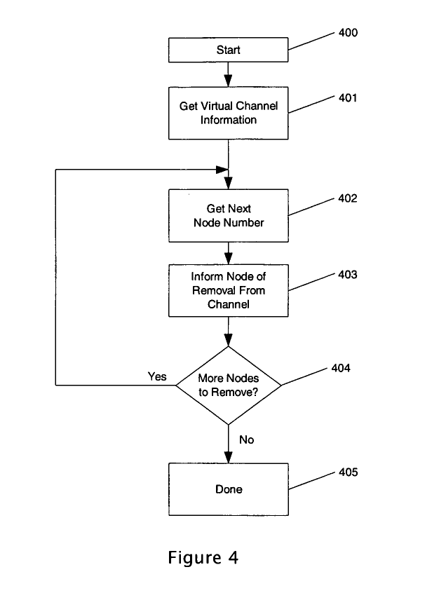

FIG. 4 is a flow diagram of the present preferred virtual channel removal process once an active channel 139 is created. Under user or application control, a virtual channel can also be removed. Once the process is started 400, a network node 140, 141, 143 gets 401 the virtual channel information. The algorithm goes through 402 each network node that is part of the virtual channel 140, 141, 143 in the list of network nodes 140, 141, 143 and informs each network node 140, 141 or 143 that is the network node 140, 141 or 143 is being removed from the virtual channel at block 403. The network node 140, 141 or 143 deletes the virtual channel information. This process tests 404 the next network node 140, 141, 143 on the active channel 139. If there is another network node 140 or 141 in test 404, the process gets 402 the next network node number. Otherwise, the process completes 405. If a network node 140, 141 or 143 cannot respond, the network node 140, 141, 143 can to be removed later using the same process.

In the present preferred embodiment, here are two types of active channels that can be created: A control node active channel, and a peer active channel. A control node active channel is an active channel 139 where there is one network node 141 called a control node 141 responsible for setting up and controlling an active channel 139. A peer active channel is where network nodes 140, 141 can come and go and there is no central control node 140, 141 or 143 responsible for creating an active channel 139. The control node responsible for a control node active channel or any node responsible for a peer active channel can be any network node 140 or 141 on the network 142 including the bandwidth master control node 140. In a control node active channel, there is one network node 141 that is responsible for creating, adding nodes to, and deleting nodes from an active channel 139. If the control node 141 is not active, the active channel 139 cannot be established.

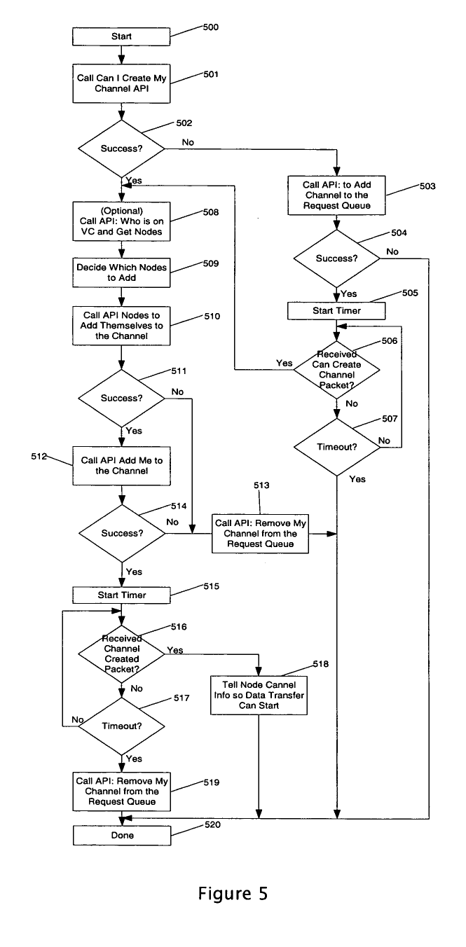

FIG. 5 is a flow diagram of the present preferred control node active channel creation process. First, the application starts 500 by calling 501 the “Can I Create My Channel” application programming interface that sends a packet to the bandwidth master control node 140. The bandwidth master control node 140 is responsible for creating virtual channels. If the response was not successful in test 502 and the network node 140, 141, 143 still wants the active channel 139 to be created when resources are available, the network node 140, 141 or 143 calls 503 the application programming interface “Add Me to the Channel.” This application programming interface call puts the request into the request queue so that the bandwidth master control node 140 can tell the network node 140, 141 or 143 when an active channel 139 can be created. If this successful in test 504, a timer is started 505 and the bandwidth master control node 140 looks 506 for the “You Can Create Your Channel” packet. If this packet is received the creation process optionally calls 508 the API “who is on VC and get nodes.” Otherwise, the process times out 507 and completes 520. Once the network node 140, 141, or 143 is informed that the active channel 139 can be created in test 502 or test 506, the network node 140, 141, or 143 goes and determines 508 which network nodes 140, 141, or 143 are on the active channel 139 if the network node 140, 141, 143 doesn't know already. The network node 140, 141, 143 decides 509 which network nodes 140, 141, 143 need to be apart of the active channel 139 if the network node 140 or 141 did not know earlier. The application calls 510 the Application Programming Interface to Tell a Node to Add Itself to the Channel. When a network node 140, 141, 143 receives a request to add the network node 140, 141 or 143 to an active channel 139, the network node 140, 141, or 143 informs the bandwidth master control node 140 and requests that the network node 140, 141 or 143 be added to the active channel 139. If this is successful, the process responds 510 to the Tell a Node to Add Itself to the Channel message. If test 511 was not successful, the control node 141 calls 513 the “Remove My Channel from the Request Queue” application programming interface which ends the Active Channel creation. Otherwise, the control node 141 will add 512 the control node 141 to the active channel 139. If there is a failure in test 514, the control node 141 calls 513 the “Remove My Channel from the Request Queue” application programming interface. Otherwise, the control node 141 starts 515 a timer and waits for the packet that indicates that the active channel 139 was created. Once control node 141 receives 516 the packet that indicates the active channel 139 was created, the control node 141 tells 518 all the network nodes 140, 141, 143 using the active channel 139 the information necessary to use the active channel 139 and completes the process 520. If the timer expires in test 517, the control node 141 calls 519 the “Remove My Channel from the Request Queue” application programming interface to remove the request and the process completes 520.

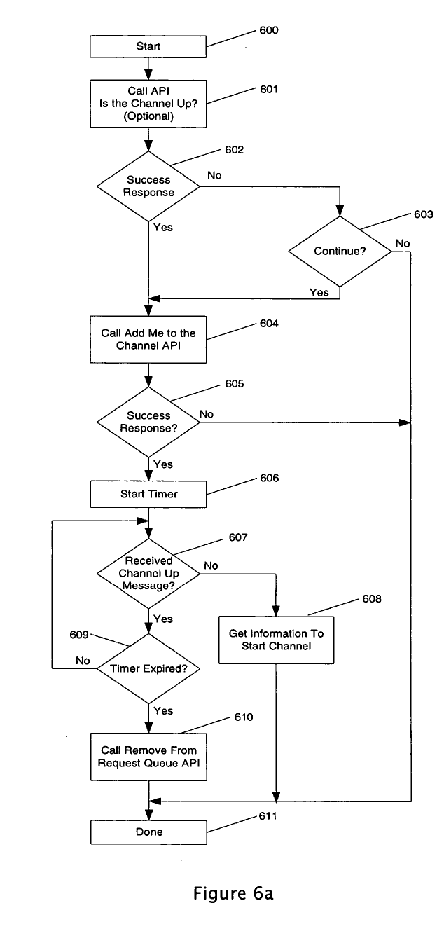

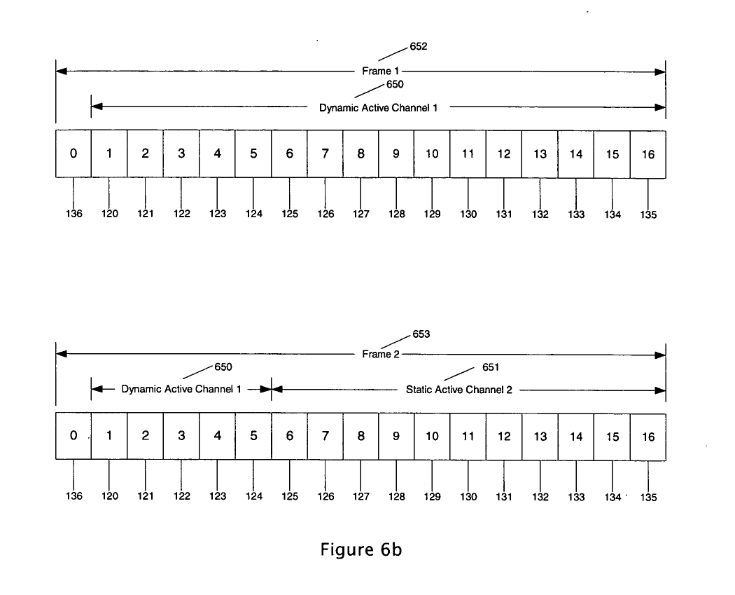

For peer networks, the process happens differently. This is because in a peer network, any network node 140 or group of network nodes 140, 141, 143 can be up at any time. For this reason, any network node 140, 141, 143 can initiate the process that creates an active channel 139. A network node 140, 141 or 143 can request to be added to an active channel 139, but an active channel 139 will not be created until at least two network nodes 140, 141 have requested to be added to the active channel 139. FIG. 6a is a flow diagram of the present preferred active channel 139 creation process for a peer active channel. On a peer active channel, a network node 140 or 141 can optionally go out 600 and see if the active channel 139 is up 601. In test 602 if the response is unsuccessful, the network node 140, 141, 143 can decide if the network node 140, 141, 143 wants to continue in test 603 or quit. If the network node 140, 141, 143 wants to quit, the process completes 611. If the network node 140, 141, 143 wants to continue, network node 140, 141, 143 calls 604 the Application Programming Interface Add Me to a Channel. Step 604 is also called if test 602 is successful. If test 605 is unsuccessful the process completes 611. Otherwise, if test 605 is successful, the network node 140, 141 or 143 starts a timer 606 in which the network node 140, 141 or 143 looks 607 for the channel is up packet. If the network node 140, 141, 143 receives this message the network node 140, 141, 143 joins 608 the active channel 139 and the process completes 611. Otherwise, if there is a timeout 609, the network node 140, 141, 143 removes 610 the network node's 140, 141, 143 request to be added from the request queue and ends the process 611. This process works the same for a network node 140, 141 or 143 being added after an active channel 139 is up. To remove an active channel 139, a network node 140, 141 or 143 can call the remove a channel API. The bandwidth master control node 140 will inform each network node 140, 141, 143 that is currently apart of the active channel 139 that the active channel 139 is being torn down.

FIG. 6b is a diagram of the present preferred dynamic active channel resizing. When a dynamic active channel 650 is created, there are two fields: The minimum bandwidth value and maximum bandwidth value. These fields are used by the bandwidth master control node 140 to create dynamic active channels 650 that can be increased or decreased based on available bandwidth. Active channels can be either static active channels 651 or dynamic active channels 650. A dynamic active channel 650 is one where the dynamic active channel's 650 size (the number of time slots 120-135 the active channel 650 uses) can change dynamically and a static active channel 651 will always require the same number of time slots 125-135 in this example. FIG. 6b depicts a static active channel 651 that uses 11 time slots 125-135. The size of a static active channel 651 can be any size from one time slot to the maximum number of time slots 120-135 that the system uses. A dynamic active channel 650 can be resized on the fly down to the minimum bandwidth value or up to the maximum bandwidth value. The minimum bandwidth field and maximum bandwidth fields will be the same for a static active channel 651. These fields are coupled with the bandwidth priority value are used to track the priority of the dynamic active channel 650 or static active channel 651 and whether the channel is a static active channel 651 or a dynamic active channel 650. The preferred embodiment uses the following four priorities: 1. Guaranteed Priority, 2. High Priority, 3. Normal Priority, and 4. Low Priority. Bandwidth is allocated on a priority basis, thus allowing a higher priority dynamic active channels 650 or static active channels 651 to take bandwidth from lower priority channels. When a dynamic active channel 650 is first created the dynamic active channel 650 takes all free time slots up to the maximum bandwidth value. Dynamic active channel one 650 has a minimum bandwidth value of one and a maximum bandwidth value of fifteen. Frame one 652 shows dynamic channel one 650 taking all time slots 120-135 when dynamic active channel one 650 is first created on an unused network 142. When a new channel is created (static or dynamic) bandwidth is taken from dynamic channels 650. For example, if after dynamic active channel one 650 is created, the dynamic active channel one 650 is dropped in frame two 653 to 5 time slots 120-124 as a new static active channel one 651 is created even if static active channel one 651 is a lower priority. The minimum bandwidth value and the maximum bandwidth values are only limited by the number of time slots 120-135 available. Once there are no dynamic slots available, active channels are created or deleted based on priority. Priority is not limited to but in the present preferred embodiment is on a first come first serve basis. This means that a new active channel cannot be created if all the slots are allocated by active channels at the same or higher priority.

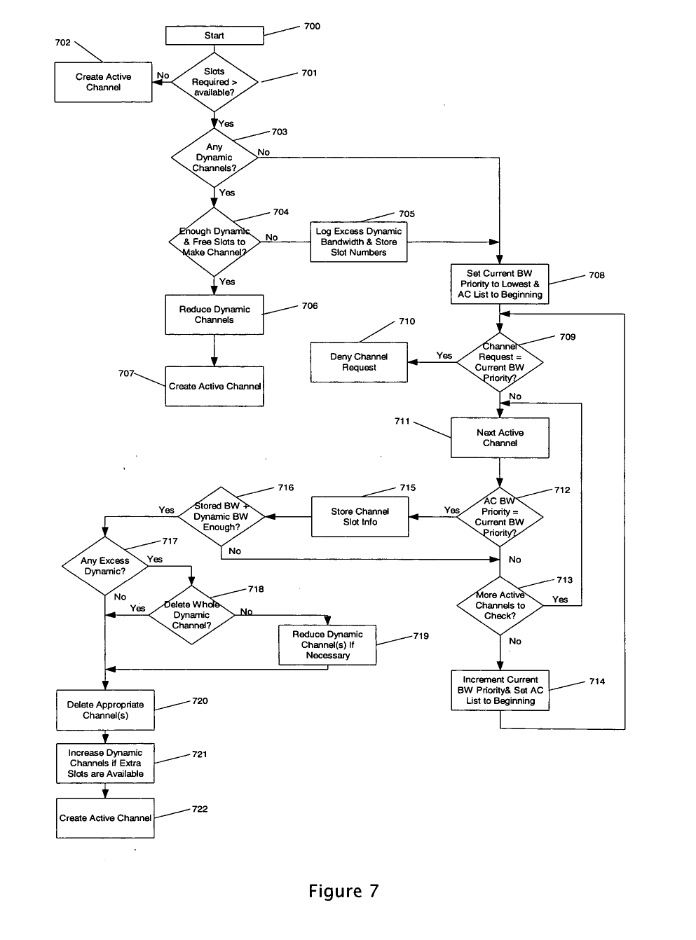

FIG. 7 is a flow diagram of the preferred process for bandwidth allocation using channel priorities. Once a new active channel 651 needs to be created 700, the bandwidth master control node 140 first looks 701 to see if there are enough free time slots 120-135 to create the new active channel 651. An active channel 651 will be created if there are at least enough free time slots 120-135 to meet the minimum bandwidth value. If so, the new active channel 651 is created 702. Otherwise, the bandwidth master control node 140 looks 703 to see if there are any dynamic active channels 650. The process checks 704 to see if there are enough dynamic and free time slots 120-135 to create the new active channel 651. If the process determines that the dynamic channels 650 have enough excess bandwidth (the difference between the minimum bandwidth value and the current size of the dynamic active channel 650) to create the new active channel 651, the dynamic active channel(s) 650 size is reduced 706 and the new active channel 651 is created 707. If the time slots 120-125 to create the new active channel 651 are coming from multiple dynamic active channels 650, the time slots 120-135 used come from the lowest priority dynamic active channel 650 first in the present preferred embodiment. If the active channels are at the same priority, the process is done (but not required to) on a first come first serve basis. If there are not enough excess dynamic time slots 120-135 available 704, the time slots 120-135 are logged 705 and stored for use later. If there is not enough bandwidth at steps 703 or 705, the current bandwidth priority value is set 708 to the lowest priority. The current bandwidth priority value is used to search through the active channel list for priorities that match it. The active channel list is set 708 to point to the beginning of the list of active channels. The request to build the new active channel 651 is checked 709 to see if the new active channel 651 is at the current search bandwidth priority. If so, a deny channel packet is sent 710 to the control node 141 and the process ends. Otherwise, the channel search process continues by getting 711 the next active channel from the list. The current active channel's bandwidth priority is compared 712 to the current search bandwidth priority. If a match is not found, the process tests 713 to see if there are more active channels in the list. If there are more active channels in the list to check 713, the process gets the next active channel in the list 711. Otherwise if test 713 is no, the active channel list search pointer is set 714 back to the beginning, the current bandwidth priority is incremented, and the process checks to see if the new channel request is equal 709 to the current bandwidth priority. When an active channel is found that is at a lower bandwidth priority than the new active channel 651 and is at the current search bandwidth priority in test 712, the information is stored 715. This information along with the slot information of any excess dynamic channel slots 120-135 from step 705 and any previous lower priority time slots 120-135 are checked 716 to see if there are enough time slots 120-135 to make the new active channel 651. If not, the process returns to the channel search process and checks 713 to see if there are more active channels in the list. Otherwise, the process of creating the new active channel 651 begins. If there are excess dynamic slots available 717, the bandwidth master control node 140 checks to see if the whole dynamic active channel 650 to which the excess dynamic time slots 120-135 are tied needs to be deleted 718. If not, the dynamic active channel's 650 size is reduced 719 if necessary. It may not be necessary to reduce the active dynamic channel 650 if the excess dynamic time slots 120-135 are not great enough to be used in the new active channel 651 in step 719. The necessary channel or channels are deleted 720. If there are any excess slots that can be used in dynamic channels 650, the excess slots are reassigned 721 to the appropriate channel or channels. Finally, the new active channel 650 is created 722.

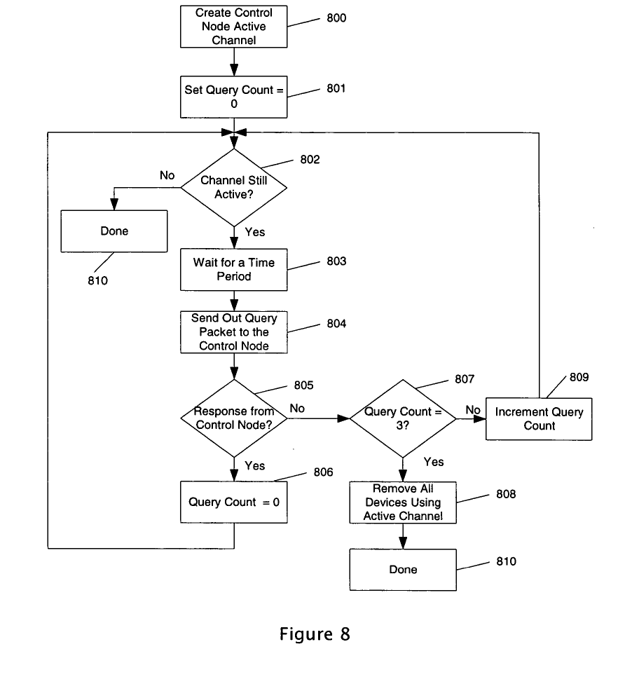

FIG. 8 is a flow diagram of the present preferred process for bandwidth reclamation in a control node active channel. The process begins when a control node active channel is created 800 on the bandwidth master control node 140. The control node active channel has a control node 141 and a network node 143 that use the control node active channel. The query count is then set 801 to zero. The process then tests 802 to see if the control node active channel is still active. If not the process is done 810. Otherwise, if the control node active channel is still active 802, the process waits 803 for a period of time. The process sends 804 out a query packet to the control node 141. If a response to the query packet is received in test 805 from the control node 141, the query count is set 806 to zero and the process tests 802 to see if the control node active channel is still active. Otherwise, if there is no response from the control node 141 in test 805, the query count is checked 807 to see if it is three. In the present preferred embodiment, the query count is three, but this value could be dynamic or another value as the needs of the system require. If the query count is three 807, all network nodes 141, 143 using the control node active channel are removed 808 from the control node active channel by sending remove from channel packets to each network node using the control node active channel and the process is done 810. Otherwise, if the query count is not three in test 807, the process increments 809 the query count and checks 802 to see if the control node active channel is still active.

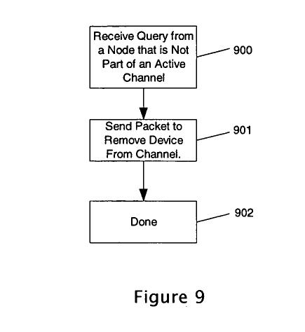

FIG. 9 is a flow diagram of the present preferred process for notifying network nodes that the network node is no longer part of an active channel. When a control node 141 or a network node 143 cannot see query packets from the bandwidth control node master 140 for reasons such as network noise and the like, these network nodes may have been removed from an active channel without being informed. If a network node 141, 143 cannot see the bandwidth master control node 140; the network nodes 141, 143 send query packets to the bandwidth master control node 140. If the bandwidth master control node 140 receives 900 a query from a network node 140 or a control node 141 and that node is no longer apart of the active channel associated with the query, the bandwidth master control node 140 will then send 901 a packet to remove network node 140 or 141 from the active channel. The process is then done 902.

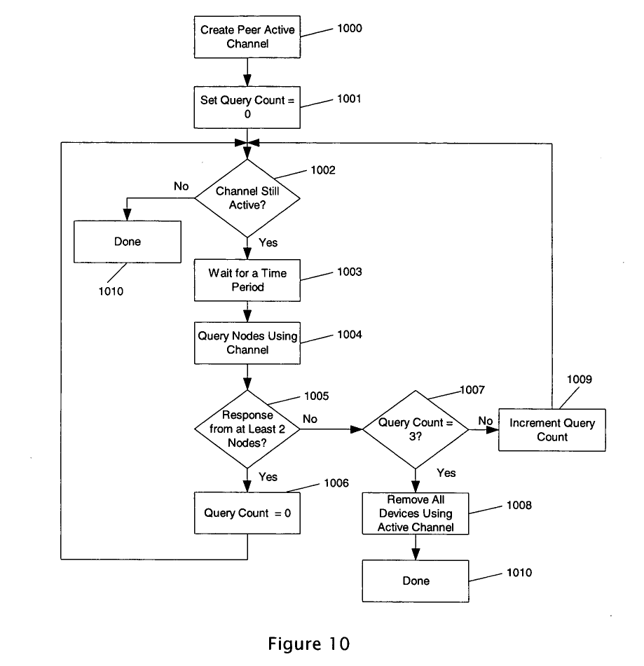

FIG. 10 is a diagram of the present preferred process for bandwidth reclamation in a peer active channel. The process begins when a peer active channel is created 1000 on the bandwidth master control node 140 where the peer channel has two network nodes 141, 143 that use the peer channel. The query count is then set 1001 to zero. The process then tests 1002 to see if the peer active channel is still active. If not the process is done 1010. Otherwise, if the peer active channel is still active 1002, the process waits 1003 for a period of time. The process sends 1004 out query packets to network nodes 141, 143 on the peer active channel until at least two network nodes 141, 143 respond or all network nodes have been queried. If a response to at least two of the query packets is received in test 1005, the query count is set 1006 to zero and the process tests 1002 to see if the peer active channel is still active. Otherwise, if there is no response from at least two network nodes 141 and 143 in test 1005, the query count is checked 1007 to see if it is three. In the present preferred embodiment, the query count is three, but this value could be dynamic or another value as the needs of the system require. If the query count is three 1007, all the network nodes 141, 143 using the peer active channel are removed 1008 from the peer active channel by sending remove from channel packets to each network node 141, 143 using the peer active channel and the process is done 1010. Otherwise, if the query count is not three in test 1007, the process increments 1009 the query count and checks 1002 to see if the peer active channel is still active.

These data transportation methods are designed so that these data transportation methods will run over a variety of networks, but are not limited to such types of networks as AC power line, DC power line, light frequency (fiber, infrared, light, and the like), Radio Frequency (RF) networks (wireless such as 802.11b, and the like), acoustic networks, and wired networks (coax, twisted pair, and the like).

In addition, these data transportation methods can be implemented using a variety of processes, but are not limited to computer hardware, microcode, firmware, software, and the like.

The described embodiments of this invention are to be considered in all respects only as illustrative and not as restrictive. Although specific flow diagrams, block diagrams and frame formats are provided, the invention is not limited thereto. The scope of this invention is, therefore, indicated by the claims rather than the foregoing description. All changes, which come within the meaning and range of equivalency of the claims, are to be embraced within their scope.

1. A method for bandwidth allocation on a network comprising:
A. building an active channel dynamically from one or more time slots on a time division multiplexed network; and
B. resizing said active channel dynamically based on one of the items selected from the group consisting of a minimum bandwidth value, a maximum bandwidth value, and a bandwidth priority value.

2. A method for bandwidth allocation on a network as recited in claim 1, further comprising the step of creating a virtual channel which is used to instantiate said active channel.

3. A method for bandwidth allocation on a network as recited in claim 2, wherein building said active channel further comprises building said active channel on a single network.

4. A method for bandwidth allocation on a network as recited in claim 2, wherein building said active channel further comprises building said active channel on a time division multiplexed network consisting of 16 time slots and a framing time slot.

5. A method for bandwidth allocation on a network as recited in claim 2, wherein resizing said active channel further comprises resizing said active channel based on four said bandwidth priority values.

6. A method for bandwidth allocation on a network as recited in claim 2, wherein building said active channel further comprises building said active channel with said one or more time slots of equal size.

7. A method for bandwidth allocation on a network as recited in claim 2, further comprising the step of encrypting an active channel.

8. A method for bandwidth allocation on a network as recited in claim 2, wherein building said active channel further comprises building said active channel from said one or more time slots which are contiguous.

9. A method for bandwidth allocation on a network as recited in claim 2, wherein building said active channel further comprises building said active channel from said one or more time slots which are non-contiguous.

10. A method for bandwidth allocation on a network as recited in claim 2, wherein building said active channel further comprises building said active channel on said network which further comprises a network selected from the group consisting of a power line network, a wireless network, a light frequency network, an acoustic network, and a wired network.

11. A method for bandwidth allocation on a network comprising:
A. building an active channel dynamically from one or more time slots in a time division multiplexed network; and
B. deleting an active channel dynamically based on one of the items selected from the group consisting of a minimum bandwidth value, a maximum bandwidth value, and a bandwidth priority value.

12. A method for bandwidth allocation on a network as recited in claim 11, further comprising the step of creating a virtual channel which is used to instantiate said active channel.

13. A method for bandwidth allocation on a network as recited in claim 12, wherein deleting said active channel further comprises building said active channel on a single network.

14. A method for bandwidth allocation on a network as recited in claim 12, wherein deleting said active channel further comprises deleting said active channel on a time division multiplexed network consisting of 16 time slots and a framing time slot.

15. A method for bandwidth allocation on a network as recited in claim 12, wherein deleting said active channel further comprises deleting said active channel based on four said bandwidth priority values.

16. A method for bandwidth allocation on a network as recited in claim 12, wherein deleting said active channel further comprises deleting said active channel with said one or more time slots of equal size.

17. A method for bandwidth allocation on a network as recited in claim 12, further comprising the step of encrypting an active channel.

18. A method for bandwidth allocation on a network as recited in claim 12, wherein deleting said active channel further comprises deleting said active channel from said one or more time slots which are contiguous.

19. A method for bandwidth allocation on a network as recited in claim 12, wherein deleting said active channel further comprises deleting said active channel from said one or more time slots which are non-contiguous.

20. A method for bandwidth allocation on a network as recited in claim 12, wherein deleting said active channel further comprises deleting said active channel on said network which further comprises a network selected from the group consisting of a power line network, a wireless network, a light frequency network, an acoustic network, and a wired network.

21. A method for bandwidth allocation on a network comprising:
A. building an active channel dynamically from time slots in a time division multiplexed network based on one of the items selected from the group consisting of a minimum bandwidth value, a maximum bandwidth value, and a bandwidth priority value.

22. A method for bandwidth allocation on a network as recited in claim 21, further comprising the step of creating a virtual channel which is used to instantiate said active channel.

23. A method for bandwidth allocation on a network as recited in claim 22, wherein building said active channel further comprises building said active channel on a single network.

24. A method for bandwidth allocation on a network as recited in claim 22, wherein building said active channel further comprises building said active channel on a time division multiplexed network consisting of 16 time slots and a framing time slot.

25. A method for bandwidth allocation on a network as recited in claim 22, wherein resizing said active channel further comprises resizing said active channel based on four said bandwidth priority values.

26. A method for bandwidth allocation on a network as recited in claim 22, wherein building said active channel further comprises building said active channel with said one or more time slots of equal size.

27. A method for bandwidth allocation on a network as recited in claim 22, further comprising the step of encrypting an active channel.

28. A method for bandwidth allocation on a network as recited in claim 22, wherein building said active channel further comprises building said active channel from said one or more time slots which are contiguous.

29. A method for bandwidth allocation on a network as recited in claim 22, wherein building said active channel further comprises building said active channel from said one or more time slots which are non-contiguous.

30. A method for bandwidth allocation on a network as recited in claim 22, wherein building said active channel further comprises building said active channel on said network which further comprises a network selected from the group consisting of a power line network, a wireless network, a light frequency network, an acoustic network, and a wired network.

31. A method for bandwidth reclamation on a network comprising:
A. building ah active channel dynamically from time slots in a time division multiplexed network;
B. sending query packets to nodes using said active channel; and
C. removing said active channel when one or more network nodes fail to respond to query packets.

32. A method for bandwidth reclamation on a network as recited in claim 31, further comprising the step of creating a virtual channel which is used to instantiate said active channel.

33. A method for bandwidth reclamation on a network as recited in claim 32, wherein building said active channel further comprises building said active channel with a single node using said active channel.

34. A method for bandwidth reclamation on a network as recited in claim 32, wherein building said active channel further comprises building said active channel from any one of said one or more network nodes using said active channel.

35. A method for bandwidth reclamation on a network as recited in claim 32, wherein removing said active channel further comprises removing said active channel if one or less of said network nodes responds to said query packets.

36. A method for bandwidth reclamation on a network as recited in claim 32, further comprising the step of removing a node from an active channel by sending a remove from channel message.

37. A system for bandwidth allocation on a network comprising:
A. a plurality of network nodes forming a network;
B. wherein one or more of said plurality of network nodes further comprises a bandwidth master control node responsible for bandwidth allocation on said network;
C. said network which further comprises a time division multiplexed data transfer mechanism which is divided into a plurality of time slots, wherein said time slots are grouped together to form one or more active channels by said bandwidth master control node; and
D. wherein said one or more active channels are dynamically resized based on one of the items selected from the group consisting of a minimum bandwidth value, a maximum bandwidth value, and a bandwidth priority value.

38. A system for bandwidth allocation on a network as recited in claim 37 wherein a virtual channel is created which is used to instantiate said one or more active channels.

39. A system for bandwidth allocation on a network as recited in claim 38 wherein said data transfer mechanism further comprises 16 time slots and a framing time slot.

40. A system for bandwidth allocation on a network as recited in claim 38 wherein said bandwidth priority value comprises four priorities.

41. A system for bandwidth allocation on a network as recited in claim 38 wherein said time slots are of equal size.

42. A system for bandwidth allocation on a network as recited in claim 38 wherein at least one of said one or more active channels are encrypted.

43. A system for bandwidth allocation on a network as recited in claim 38 wherein said one or more active channels are created using said plurality of time slots which are contiguous.

44. A system for bandwidth allocation on a network as recited in claim 38 wherein said one or more active channels are created using said plurality of time slots which are non-contiguous.

45. A system for bandwidth allocation on a network as recited in claim 38 wherein said network is a network selected from the group consisting of a wireless network, a light frequency network, a power line network, an acoustic network and a wired network.

46. A system for bandwidth allocation on a network comprising:
A. a plurality of network nodes forming a network;
B. wherein one or more of said plurality of network nodes further comprises a bandwidth master control node responsible for bandwidth allocation on said network;
C. said network which further comprises a time division multiplexed data transfer mechanism which is divided into a plurality of time slots, wherein said time slots are grouped together to form one or more active channels by said bandwidth master control node; and
D. wherein said one or more active channels are dynamically deleted based on one of the items selected from the group consisting of a minimum bandwidth value, a maximum bandwidth value, and a bandwidth priority value.

47. A system for bandwidth allocation on a network as recited in claim 46 wherein a virtual channel is created which is used to instantiate said one or more active channels.

48. A system for bandwidth allocation on a network as recited in claim 47 wherein said data transfer mechanism further comprises 16 time slots and a framing time slot.

49. A system for bandwidth allocation on a network as recited in claim 47 wherein said bandwidth priority value comprises four priorities.

50. A system for bandwidth allocation on a network as recited in claim 47 wherein said time slots are of equal size.

51. A system for bandwidth allocation on a network as recited in claim 47 wherein at least one of said one or more active channels are encrypted.

52. A system for bandwidth allocation on a network as recited in claim 47 wherein said one or more active channels are created using said plurality of time slots which are contiguous.

53. A system for bandwidth allocation on a network as recited in claim 47 wherein said one or more active channels are created using said plurality of time slots which are non-contiguous.

54. A system for bandwidth allocation on a network as recited in claim 47 wherein said network is a network selected from the group consisting of a wireless network, a light frequency network, a power line network, and a wired network.

55. A system for bandwidth allocation on a network comprising:
A. a plurality of network nodes forming a network;
B. wherein one or more of said plurality of network nodes further comprises a bandwidth master control node responsible for bandwidth allocation on said network; and
C. said network which further comprises a time division multiplexed data transfer mechanism which is divided into a plurality of time slots, wherein said time slots are grouped together to form one or more active channels by said bandwidth master control node.

56. A system for bandwidth allocation on a network as recited in claim 55 wherein a virtual channel is created which is used to instantiate said one or more active channels.

57. A system for bandwidth allocation on a network as recited in claim 56 wherein said data transfer mechanism further comprises 16 time slots and a framing time slot.

58. A system for bandwidth allocation on a network as recited in claim 56 wherein said bandwidth priority value comprises four priorities.

59. A system for bandwidth allocation on a network as recited in claim 56 wherein said time slots are of equal size.

60. A system for bandwidth allocation on a network as recited in claim 56 wherein at least one of said one or more active channels are encrypted.

61. A system for bandwidth allocation on a network as recited in claim 56 wherein said one or more active channels are created using said plurality of time slots which are contiguous.

62. A system for bandwidth allocation on a network as recited in claim 56 wherein said one or more active channels are created using said plurality of time slots which are non-contiguous.

63. A system for bandwidth allocation on a network as recited in claim 56 wherein said network is a network selected from the group consisting of a wireless network, a light frequency network, a power line network, and a wired network.

64. A system for bandwidth reclamation on a network comprising:
A. a plurality of network nodes forming a network;
B. wherein one or more of said plurality of network nodes further comprises a bandwidth master control node responsible for bandwidth allocation on said network;
C. said network which further comprises a time division multiplexed data transfer mechanism which is divided into a plurality of time slots, wherein said time slots are grouped together to form one or more active channels by said bandwidth master control node; and
D. wherein said one or more active channels are reclaimed by said bandwidth master control node based on the number of responses to query packets.

65. A system for bandwidth reclamation as recited in claim 64 wherein said number responses to query packets is zero.

66. A system for bandwidth reclamation as recited in claim 64 wherein said number responses to query packet is one or less.

67. A system for bandwidth reclamation as recited in claim 64 wherein said active channel can only be created by a control node.

68. A system for bandwidth reclamation as recited in claim 64 wherein said active channel can be created by any one of said plurality of network nodes.

69. A system for bandwidth reclamation as recited in claim 64 wherein at least one of said plurality of network nodes are removed from said one or more active channels by receiving a packet from said bandwidth master control node.
